(19) United States
(12) Patent Application Publication
(10) Pub. No.: US 2015/0345515 A1
(43) Pub. Date: Dec. 3, 2015

(54) TURBOCHARGER

(71) Applicant: OTICS Corporation, Nishio-city (JP)

(72) Inventor: Tomoyuki ISOGAI, Aichi (JP)

(73) Assignee: OTICS Corporation, Nishio-city (JP)

(21) Appl. No.: 14/724,977

(22) Filed: May 29, 2015

(30) Foreign Application Priority Data
May 30, 2014 (JP) 2014-112497

(51) Int. Cl. F04D 29/70; F02B 37/04; F04D 29/44; F04D 29/28; F04D 17/10; F04D 29/42

(52) U.S. Cl. CPC F04D 29/701; F04D 17/10; F04D 29/4206; F04D 29/441; F04D 29/284; F02B 37/04

(57) ABSTRACT

A turbocharger includes a compressor housing and a bearing housing. The compressor housing includes a diffuser surface, and the bearing housing includes an opposite surface. An adhesion preventing part is disposed on each of the diffuser surface and the opposite surface. The adhesion preventing part is provided with a surface forming part and a tank part and is configured so that air is ejected through the ejection holes of the surface forming part to a diffuser passage. An air supply passage is formed in the compressor housing and the bearing housing. At least one of the compressor housing and the bearing housing includes a depurant injection port for supplying a depurant having compatibility with deposits to the tank part through the air supply passage.

### CROSS-REFERENCE

This application claims priority to Japanese patent application. no. 2014-112497 filed on May 30, 2014, the contents of which are entirely incorporated herein by reference.

### BACKGROUND OF THE INVENTION

1. Field of the Invention

The present invention relates to a turbocharger including a compressor housing and a bearing housing.

2. Description of the Related Art

A turbocharger mounted on an automobile or the like is configured to compress intake air by a compressor and discharge the air toward an internal-combustion engine (see JP-A-2002-180841).

That is, the turbocharger includes with a compressor housing provided therein with an air flow path in which an impeller is placed; and a bearing housing rotatably supporting a rotor shaft to one end of which the impeller is fixed. The air flow path includes an intake port for sucking air to the impeller, and a discharge scroll chamber into which the compressed air discharged from the impeller flows.

The compressor housing includes a shroud surface opposed to the impeller, and a diffuser surface extending from the shroud surface toward the discharge scroll chamber. The bearing housing forms a diffuser passage between the bearing housing and the diffuser surface of the compressor housing.

In addition, the turbocharger is configured so that the compressed air discharged from the impeller passes through the diffuser passage, flows into the discharge scroll chamber, and is further discharged from the discharge scroll chamber to the internal-combustion engine side.

### PATENT LITERATURE

### [Patent Literature 1] JP-A-2002-180841

For example, some internal-combustion engines include a blowby gas reflux apparatus (hereinafter referred to as the PCV) for cleaning up interiors of a crankcase and a head cover by flowing back a blowby gas generated inside the crankcase to an intake passage. In this case, oil (oil mist) contained in the blowby gas may in some cases flow out from the PCV to an intake passage on the upstream side of a compressor in a turbocharger.

If an outlet air pressure of the compressor is high at this time, an outlet air temperature of the compressor is also high. Accordingly, the oil flowing out of the PCV may accumulate on the diffuser surface of a compressor housing, a surface of a bearing housing opposed to the diffuser surface, and the like as deposits due to an evaporation-induced increase in concentration and viscosity. The deposits thus accumulated may narrow the diffuser passage to cause performance degradation in the turbocharger, and further cause an output power drop in the internal-combustion engine.

It is conceivable that the outlet air temperature of the compressor is suppressed to some degree, in order to prevent such deposit accumulation in the diffuser passage as described above. In this case, however, the turbocharger fails to fully exert performance and has difficulty in fully increasing the output power of the internal-combustion engine.

The present invention has been made under such a background to provide a turbocharger capable of preventing the adhesion of deposits in a diffuser passage.

### SUMMARY OF THE INVENTION

One aspect of the present invention provides a turbocharger including:
a compressor housing provided therein with an air flow path in which an impeller is placed; and
a bearing housing rotatably supporting a rotor shaft having one end to which the impeller is fixed, wherein
the air flow path includes an intake port for sucking air to the impeller, and a discharge scroll chamber formed on an outer circumferential side of the impeller in a circumferential direction to guide compressed air discharged from the impeller to the outside,
the compressor housing includes a shroud surface opposed to the impeller, and a diffuser surface extending from the shroud surface toward the discharge scroll chamber,
the bearing housing includes an opposite surface opposed to the diffuser surface of the compressor housing and forming a diffuser passage between the opposite surface and the diffuser surface,
each of the diffuser surface of the compressor housing and the opposite surface of the bearing housing is provided with an adhesion preventing part for preventing adhesion of deposits,
the adhesion preventing part includes a surface forming part having a multitude of fine ejection holes open to the diffuser passage, and a tank part covered with the surface forming part from a side of the diffuser passage, and is configured so as to eject air from the tank part through the ejection holes of the surface forming part to the diffuser passage,
the compressor housing and the bearing housing include air supply passages for supplying air to the tank parts, and
at least one of the compressor housing and the bearing housing includes a depurant injection port for supplying a depurant compatible with the deposit to the tank part through the air supply passage.

In the turbocharger, the adhesion preventing part is disposed on each of the diffuser surface of the compressor housing and the opposite surface of the bearing housing. The adhesion preventing part is configured so that air is ejected from the tank part through the ejection holes of the surface forming part to the diffuser passage. This configuration secures a distance between a deposit coming flying to the adhesion preventing part and the surface of the adhesion preventing part on the diffuser passage side. It is therefore possible to suppress an intermolecular force between the deposit and the surface of the adhesion preventing part on the diffuser passage side. Accordingly, the deposit coming flying to the adhesion preventing part is blown off by supply air (compressed air) flowing through the diffuser passage. As a result, the deposit is prevented from adhering to the surface of the adhesion preventing part on the diffuser passage side.

In addition, since each ejection hole of the adhesion preventing part is microscopic, the deposit is less likely to go into the ejection hole even if the deposit comes into contact with the adhesion preventing part. Also for this reason, the deposit is prevented from adhering to the surface of the adhesion preventing part. Also, since the ejection holes are microscopic, the ejection holes do not disturb a stream of compressed air flowing through the diffuser passage although disposed so as to face the diffuser passage.

In the case that the outlet temperature of the compressor is relatively low, liquid oil mist may come flying to the diffuser passage. The liquid oil mist is, however, repelled by air ejected from the adhesion preventing part to the diffuser passage (hereinafter referred to as “ejected air” where appropriate) and blown off by supplied air. Accordingly, it is possible to prevent the oil mist from accumulating in the diffuser passage as the deposit.

The compressor housing and the bearing housing each include the air supply passage for supplying air to the tank part. This configuration allows members, such as pipes, for air supply to the tank part to be reduced or eliminated. Thus, it is possible to reduce the number of components of the turbocharger and thereby compactify the turbocharger.

As described above, the ejected air prevents the deposit from adhering to surfaces of the adhesion preventing part. However, if the deposit firmly adheres to the surface of the adhesion preventing part and is hardly removed from the surface with ejected air alone, the deposit may degrade the turbocharger in the performance.

Hence, at least one of the compressor housing and the bearing housing includes the depurant injection port for supplying the depurant having compatibility with the deposit to the tank part. This configuration allows the depurant to be supplied from the tank part through the ejection holes of the adhesion preventing part to the diffuser surface or the opposite surface. Accordingly, the deposit can be removed with the depurant even if the deposit firmly adheres to the surface of the adhesion preventing part.

In addition, since the depurant is supplied to the tank part through the air supply passage, any supply passages for supplying the depurant to the tank part need not be provided newly. That is, the air supply passage has the role of supplying the depurant, as well as air, to the tank part. It is therefore possible to more securely prevent the deposit from accumulating in the diffuser passage, without complicating the structure of the turbocharger in particular.

As described above, according to the present invention, it is possible to provide a turbocharger capable of preventing the adhesion of deposits in a diffuser passage.

### BRIEF DESCRIPTION OF THE DRAWINGS

FIG. 1 is a partially cross-sectional explanatory view of a turbocharger in Embodiment 1;

FIG. 2 is an enlarged cross-sectional explanatory view illustrating an adhesion preventing part in Embodiment 1;

FIG. 3 is an enlarged cross-sectional explanatory view illustrating part of a surface formation section in Embodiment 1;

FIG. 4 is an enlarged cross-sectional explanatory view illustrating a situation in which a deposit comes flying to a surface of the adhesion preventing part and another deposit has contact with the surface in Embodiment 1;

FIG. 5 is an enlarged cross-sectional explanatory view illustrating a situation in which a depurant is brought into contact with deposits firmly adherent to the surface of the adhesion preventing part in Embodiment 1;

FIG. 6 is an explanatory view illustrating a diffuser passage, a discharge scroll chamber and an impeller in Embodiment 2, taken from the axial direction of the impeller;

FIG. 7 is an enlarged cross-sectional explanatory view illustrating an adhesion preventing part in Embodiment 2;

FIG. 8 is an explanatory view illustrating an opposite surface constituting the diffuser, passage and the impeller in Embodiment 2, taken from the axial direction of the impeller;

FIG. 9 is an enlarged cross-sectional explanatory view illustrating a situation in which an ejector effect has taken place in Embodiment 2; and

FIG. 10 is a partially cross-sectional explanatory view of a turbocharger in Embodiment 3.

### DESCRIPTION OF THE PREFERRED EMBODIMENTS

The above-described bearing housing may be an integrally-configured housing or a housing configured by combining a plurality of members. That is, in the latter case, the bearing housing can be configured to, for example, include a bearing main unit and a back plate as a separate component. The back plate is disposed between the bearing main unit and the compressor housing and faces part of the air flow path. In this case, the opposite surface is formed on the compressor-side surface of the back plate. In addition, the adhesion preventing part and at least part of the air supply passage can be formed in the back plate.

Each adhesion preventing part is preferably disposed circularly all over the diffuser surface and the opposite surface in the circumferential direction of the surfaces respectively. In this case, it is possible to prevent variation of the effect of preventing the adhesion of deposits in the diffuser passage over the entire surfaces in the circumferential direction.

In addition, the adhesion preventing part is preferably formed in each of the diffuser surface and the opposite surface respectively within a region having a length not less than half of the overall length of the diffuser passage in the radial direction. In this case, it is possible to effectively prevent the adhesion of deposits in the diffuser passage. Here, the overall length of the diffuser passage refers to the radial-direction length of a region in which the diffuser surface and the opposite surface are disposed in parallel with each other. The adhesion preventing part can also be formed over the overall length of the diffuser passage in the radial direction.

As the depurant, it is possible to use a liquid-state cleaning agent compatible with deposits, such as the Super-Check cleaning liquid made by MARKTEC Corporation.

The air supply passage communicated with the tank part provided in the compressor housing and the air supply passage communicated with the tank part provided in the bearing housing are preferably connected to each other. In this case, the depurant can be supplied from a common depurant injection port to both the tank part provided in the compressor housing and the tank part provided in the bearing housing. Thus, a single depurant injection port suffices for depurant supply. Also, work efficiency in injecting the depurant can be promoted.

### EMBODIMENTS

### Embodiment 1

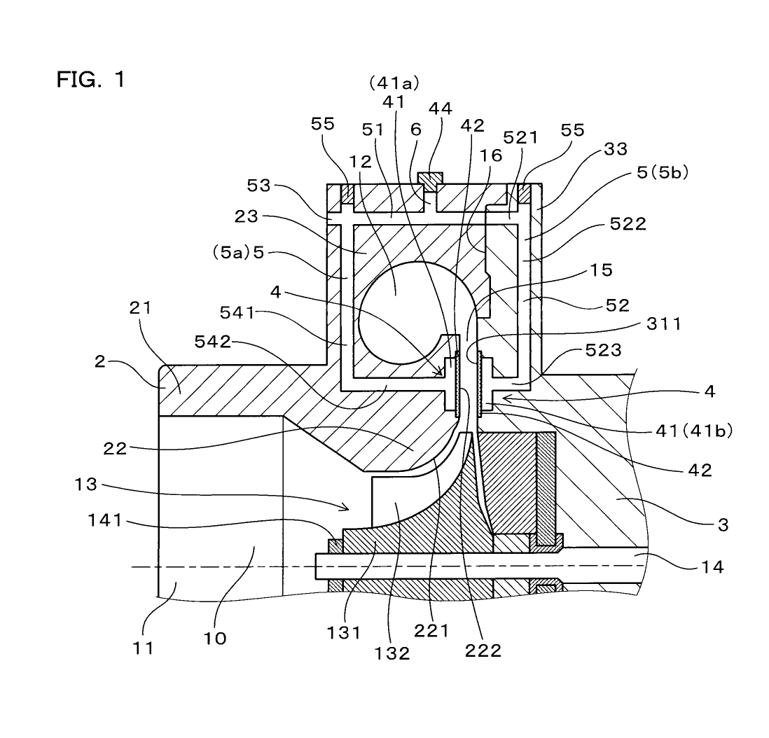

Embodiments of the above-described turbocharger will be described using FIGS. 1 to 5.

As shown in FIG. 1, a turbocharger 1 of the present embodiment includes a compressor housing 2 provided therein with an air flow path 10 in which an impeller 13 is placed; and a bearing housing 3 rotatably supporting a rotor shaft 14 having one end to which the impeller 13 is fixed.

The air flow path 10 includes an intake port 11 for sucking air to the impeller 13, and a discharge scroll chamber 12 formed on an outer circumferential side of the impeller 13 in the circumferential direction to guide compressed air discharged from the impeller 13 to the outside.

The compressor housing 2 includes a shroud surface 221 opposed to the impeller 13, and a diffuser surface 222 extending from the shroud surface 221 toward the discharge scroll chamber 12.

The bearing housing 3 includes an opposite surface 311 opposed to the diffuser surface 222 of the compressor housing 2 and forming a diffuser passage 15 between the opposite surface 311 and the diffuser surface 222.

Each of the diffuser surface 222 of the compressor housing 2 and the opposite surface 311 of the bearing housing 3 is provided with an adhesion preventing part 4 for preventing the adhesion of deposits.

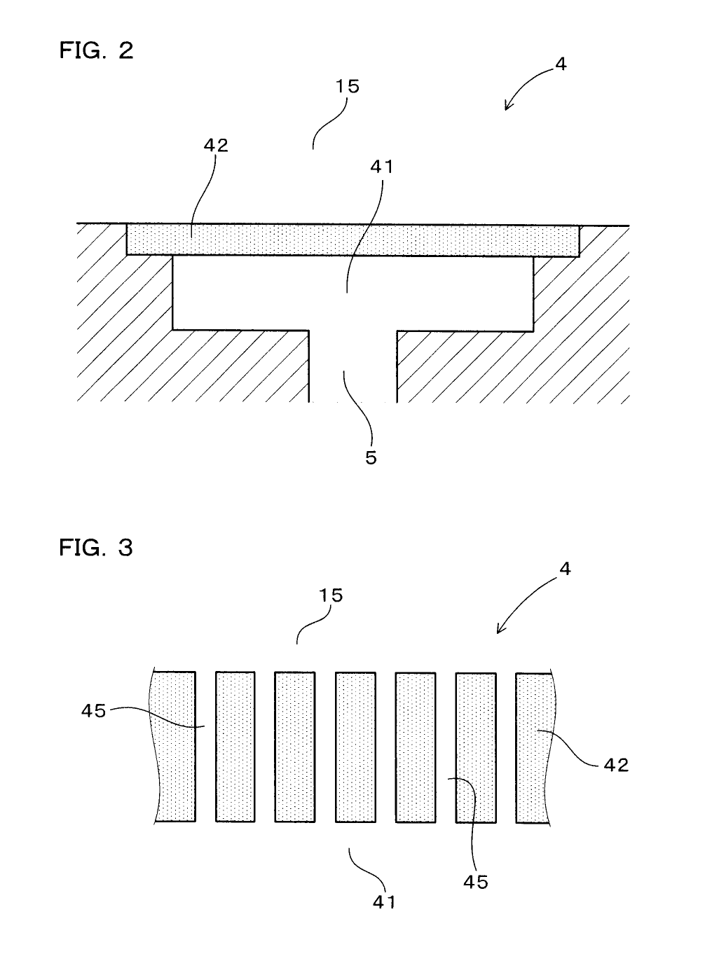

As shown in FIGS. 2 and 3, the adhesion preventing part 4 includes a surface forming part 42 having a multitude of fine ejection holes 45 open to the diffuser passage 15, and a tank part 41 covered with the surface forming part 42 from the diffuser passage 15 side. In addition, the adhesion preventing part 4 is configured so that air is ejected from the tank part 41 through the ejection holes 45 of the surface forming part 42 to the diffuser passage 15.

As shown in FIG. 1, an air supply passage 5 for supplying air to the tank part 41 is formed in each of the compressor housing 2 and the bearing housing 3. In addition, at least one of the compressor housing 2 and the bearing housing 3 includes a depurant injection port 6 for supplying a depurant compatible with deposits to the tank part 41 through the air supply passage 5.

The turbocharger 1 of the present embodiment can be used by connecting the turbocharger to an internal-combustion engine equipped with a PCV. The turbocharger 1 is configured so that a turbine is rotated by an exhaust gas discharged from the internal-combustion engine of an automobile or the like, intake air is compressed at a compressor by utilizing a rotative force of the turbine, and the compressed air is fed into the internal-combustion engine. Accordingly, the turbocharger 1 is equipped with a turbine housing (not shown) on the opposite side of the compressor housing 2 constituting an outer shell of the compressor in the axial direction of the turbocharger.

An exhaust gas flow path in which a turbine impeller is disposed is formed inside the turbine housing. The turbine impeller is fixed to the rotor shaft 14. That is, the impeller 13 of the compressor and the turbine impeller are coupled with each other by the rotor shaft 14. Thus, the turbocharger 1 is configured so that the impeller 13 of the compressor rotates along with the rotation of the turbine impeller.

The compressor housing 2 includes a tubular intake port formation section 21 forming an intake port 11, a shroud part 22 forming a shroud surface 221 and the diffuser surface 222, and a discharge scroll chamber formation section 23 forming the discharge scroll chamber 12. The diffuser surface 222 is circularly formed so as to face the opposite surface 311 of the bearing housing 3. In addition, the diffuser surface 222 forms a diffuser passage 15 between the diffuser surface 222 and the opposite surface 311 of the bearing housing 3.

The impeller 13 is disposed on the side of the inner periphery of the shroud part 22 of the compressor housing 2. The impeller 13 includes a hub 131 fixed to the rotor shaft 14 with an axial end nut 141, and a plurality of blades 132 protruding from the outer peripheral surface of the hub 131 and arrayed in the circumferential direction of the impeller. The plurality of blades 132 is disposed oppositely to the shroud surface 221 of the compressor housing 2.

The bearing housing 3 for rotatably supporting the rotor shaft 14 is disposed between the compressor housing 2 and the turbine housing. A substantially disk-shaped flange portion 33 is provided on one end side of the bearing housing 3 in the axial direction of the housing. The opposite surface 311 opposed to the diffuser surface 222 of the compressor housing 2 is circularly formed on the compressor-side surface of the flange portion 33.

As described above, the adhesion preventing part 4 is provided in each of the compressor housing 2 and the bearing housing 3. Each adhesion preventing part 4 is circularly arranged on the diffuser surface 222 of the compressor housing 2 and the opposite surface 311 of the bearing housing 3 entirely in the circumferential direction of the surfaces. In addition, the adhesion preventing part 4 is formed in the diffuser surface 222 and the opposite surface 311 within a region having a length not less than half the overall length of the diffuser passage 15 in the radial direction.

As shown in FIGS. 1 and 2, the adhesion preventing part 4 includes the tank parts 41 and the surface forming parts 42. The tank parts 41 are circular spaces formed by covering grooves circularly formed in the diffuser surface 222 of the compressor housing 2 and the opposite surface 311 of the bearing housing 3 with the surface forming part 42 from the diffuser passage 15 side. Air (exhaust gas) supplied from the air supply passage 5 is stored in the tank part 41.

When a depurant is injected from the depurant injection port 6, a liquid-state depurant is stored in this tank part 41.

As shown in FIG. 1, the air supply passage 5 includes an air supply passage 5a communicated with a tank part 41a provided in the compressor housing 2, and an air supply passage 5b communicated with a tank part 41b provided in the bearing housing 3.

The air supply passage 5a and the air supply passage 5b are connected to a common introduction port 53 provided in the compressor housing 2. That is, in the present embodiment, the introduction port 53 opened in the same direction as the intake port 11 is formed in the compressor housing 2 on the outer side of the scroll chamber 12 in the radial direction of the chamber. The two air supply passages 5 (5a and 5b) are communicated with this introduction port 53 at an end of the each passage on the opposite side of the tank part 41.

Whereas the air supply passage 5a is formed only in the compressor housing 2, the air supply passage 5b is formed across the compressor housing 2 and the bearing housing 3. That is, the air supply passage 5b is formed by series-connecting a first supply passage 51 formed in the compressor housing 2 and a second supply passage 52 formed in the bearing housing 3. The first supply passage 51 is formed in the compressor housing 2 so as to connect to the introduction port 53 in alignment with the port. The second supply passage 52 is composed of an outer axial direction section 521 opened toward the compressor housing 2 so as to connect to the first supply passage 51, a radial direction section 522 disposed extendedly inward in the radial direction from the outer axial direction section 521, and an inner axial direction section 523 formed in the axial direction from the radial direction section 522 and connected to the tank part 41b.

The air supply passage 5b is formed as a result of connecting the first supply passage 51 and the second supply passage 52 each other on a mating surface 16 between the compressor housing 2 and the bearing housing 3. A sealing member, such as an O-ring, may be located as necessary around a junction between the opening of the first supply passage 51 and the opening of the second supply passage 52 on the mating surface 16.

The air supply passage 5a connected to the tank part 41a of the adhesion preventing part 4 formed on the diffuser surface 222 of the compressor housing 2 includes a radial direction section 541 disposed extendedly inward in the radial direction from the introduction port 53, and an axial direction section 542 extending in the axial direction from the radial direction section 541 and connecting to the tank part 41a.

The shapes of the above-described air supply passages 5a and 5b are not limited in particular and various shapes may be adopted.

The depurant injection port 6 open to the outer peripheral surface (preferably the upper surface) of the compressor housing 2 is connected to the first supply passage 51. The depurant injection port 6 is formed in a location higher than the air supply passage 5 in the vertical direction and connected to the highest portion of the air supply passage 5. The depurant injection port 6 is closed by a plug member 44. The plug member 44 is detachably fitted on the depurant injection port 6. Accordingly, it is possible to inject a depurant from the depurant injection port 6 through an air supply passage 5 into the tank part 41.

The air supply passage 5 and the depurant injection port 6 are formed by boring holes as appropriate, in the compressor housing 2 and the bearing housing 3. That is, the compressor housing 2 and the bearing housing 3 can be molded by casting metal such as an aluminum alloy. Then, a plurality of appropriate holes is formed straight in appropriate positions on these castings using a drill or the like. For example, the radial direction section 541 of the air supply passage 5a is formed by boring a hole from the outer peripheral surface of the compressor housing 2 inward in the radial direction. A hole penetratingly formed in the compressor housing 2 in the axial direction outside the scroll chamber 12 serves as part of the first supply passage 51 of the air supply passage 5b. The radial direction section 522 of the second supply passage 52 of the air supply passage 5b is formed by boring a hole from the outer peripheral surface of the flange portion 33 of the bearing housing 3 inward in the radial direction. The depurant injection port 6 is formed by boring a hole from the outer peripheral surface of the compressor housing 2 toward the first supply passage 51.

The holes bored in the compressor housing 2 and the bearing housing 3 inward toward the radial direction from the outer peripheral surfaces are open to the outer peripheral surfaces. These openings are closed by plug members 55. The depurant injection port 6 is also closed by the plug member 44. Consequently, air introduced from the introduction port 53 can be supplied through the air supply passage 5 to the tank part 41 without leaking the air to the outside.

As shown in FIG. 2, the tank part 41 is formed by covering the opening side of a circular groove formed by means of cutting or the like from the diffuser surface 222 side and the opposite surface 311 side with the surface forming part 42. The surface forming part 42 is composed of a porous body, such as porous resin, metal, ceramics, glass fiber or carbon graphite, or a material equivalent to any of these materials (for example, a material formed by winding a resin film, a material formed by stacking resin sheets, or a material formed by plaiting a resin thread).

As shown in FIG. 3, the surface forming part 42 includes a multitude of ejection holes 45. The ejection holes 45 are through-holes penetrating from the diffuser passage 15-side surface to the tank part 41-side surface of the surface forming part 42. The ejection holes 45 show up on the diffuser passage 15-side surface of the surface forming part 42 and are open into the diffuser passage 15.

The size of the ejection holes 45 of the surface forming part 42 is not limited in particular, and may be varied as appropriate, in consideration of the shape of the compressor housing 2, the shape of the diffuser passage 15, supercharging pressure, and the like. The size of the ejection holes 45 may be, for example, 10 nm to 3 μm, preferably 100 nm to 1 μm, and more preferably 300 nm, in average diameter. In the present embodiment, the average diameter of the ejection holes 45 was set to 300 nm. The formation density of ejection holes 45 in the diffuser passage 15-side surface of the surface forming part 42 is 20 to 50%. Here, the formation density of the ejection holes 45 refers to the total area of ejection holes 45 per unit area. Since a multitude of microscopic ejection holes 45 are formed, the diffuser passage 15-side surface of the adhesion preventing part 4 is a finely concave-convex surface, as shown in FIG. 3.

An external feed pipe (not shown) is connected to the introduction port 53 of the air supply passage 5. The feed pipe is connected to an EGR (exhaust gas recirculation) passage through a valve or the like. Thus, part of the exhaust gas in an internal-combustion engine (EGR gas) flows from the EGR passage through the feed pipe and the air supply passage 5 into the tank part 41. Consequently, an exhaust gas (air) is supplied to the adhesion preventing part 4. The pressure of the exhaust gas (EGR gas) in the tank part 41 of the adhesion preventing part 4 is controlled so as to be higher than the pressure of compressed air inside the diffuser passage 15. An exhaust gas filter and an EGR cooler (cooling device) for cooling the exhaust gas, though not shown, are disposed in the EGR passage.

Consequently, high-pressure air (exhaust gas) is supplied to the tank part 41 through the air supply passage 5. The air (exhaust gas) is thus ejected from the surface forming part 42 of the adhesion preventing part 4 toward the diffuser passage 15.

Next, a description will be made of one example of a method for removing deposits firmly adherent to the surface forming part 42 of the adhesion preventing part 4.

When the turbocharger 1 is at a stop, a depurant is supplied from the depurant injection port 6 through the air supply passage 5 to the tank part 41. The depurant filled in the tank part 41 infiltrates into the ejection holes 45 of the surface forming part 42. Then, the depurant circulates around the entire area of the circular surface forming part 42 due to capillary action. The depurant having infiltrated into the surface forming part 42 evaporates and is supplied to the diffuser surface 222 and the opposite surface 311. Then, the deposits are softened by allowing the depurant and the deposits to be compatible with each other for a sufficient amount of time.

Thereafter, the turbocharger 1 is put in operation to eject air (exhaust gas) from the surface forming part 42 of the adhesion preventing part 4 toward the diffuser passage 15, as described above. The softened deposits are blown off by the air (exhaust gas). In the way described above, the deposits firmly adherent to the surface forming part 42 of the adhesion preventing part 4 are removed.

A depurant can be supplied to the tank part 41 at regular intervals according to the mileage, for example, when engine oil is exchanged, when a power drop in the turbocharger is detected with a sensor, or the like.

Next, a description will be made of the working effect of the present embodiment.

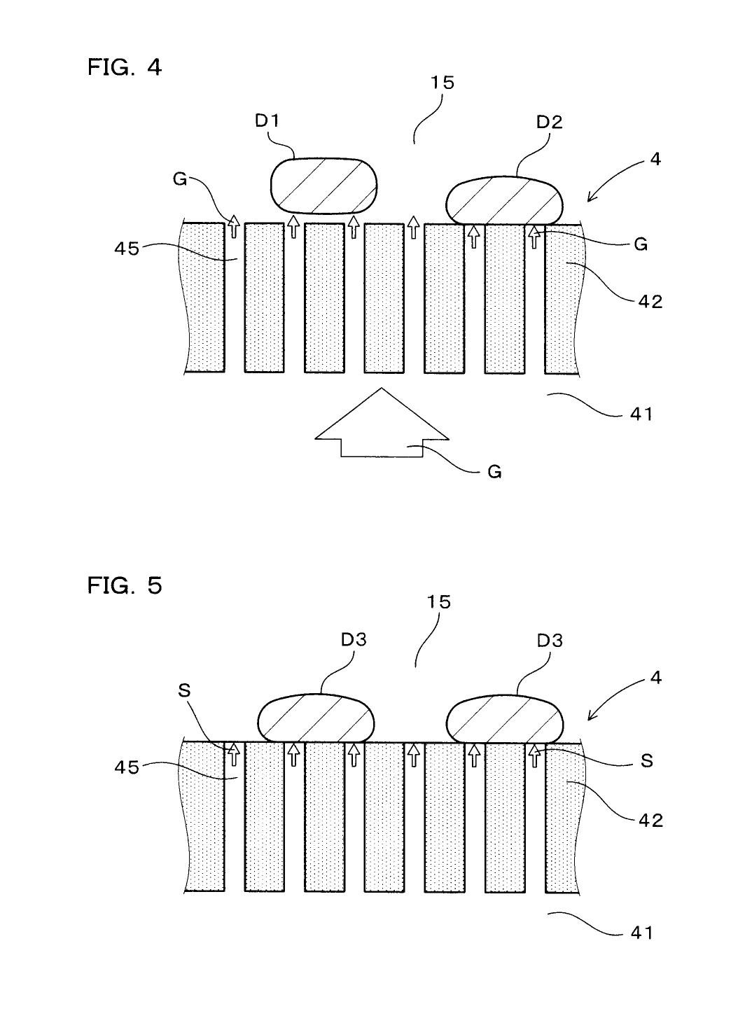

In the above-described turbocharger 1, the adhesion preventing part 4 is disposed on each of the diffuser surface 222 of the compressor housing 2 and the opposed surface 311 of the bearing housing 3. As shown in FIG. 4, the adhesion preventing part 4 is configured so that air G is ejected from the tank part 41 through the ejection holes 45 of the surface forming part 42 to the diffuser passage 15. This configuration secures a distance between a deposit D1 coming flying to the adhesion preventing part 4 and the diffuser passage 15-side surface of the adhesion preventing part 4. It is therefore possible to suppress an intermolecular force between the deposit D1 and the diffuser passage 15-side surface of the adhesion preventing part 4. Accordingly, the deposit D1 coming flying to the adhesion preventing part 4 is blown off by supply air (compressed air) flowing through the diffuser passage 15. As a result, the deposit D1 is prevented from adhering to the diffuser passage 15-side surface of the adhesion preventing part 4.

In addition, since each ejection hole 45 of the adhesion preventing part 4 is microscopic, a deposit D2 is less likely to go into the ejection hole 45 even if the deposit D2 comes into contact with the adhesion preventing part 4. Also for this reason, the deposit D2 is prevented from adhering to surfaces of the adhesion preventing part 4. Although disposed so as to face the diffuser passage 15, the ejection holes 45 do not disturb a stream of supply air flowing through the diffuser passage 15 since the ejection holes 45 are microscopic.

If the outlet temperature of the compressor is relatively low, liquid oil mist may come flying to the diffuser passage 15. The liquid oil mist is repelled by air G ejected from the adhesion preventing part 4 and blown off by supply air, however. Accordingly, it is possible to prevent the oil mist from accumulating in the diffuser passage 15 as the deposit.

The compressor housing 2 and the bearing housing 3 each include the air supply passage 5 for supplying air to the tank part 41. This configuration allows members, such as pipes, for air supply to the tank part 41 to be reduced. Thus, it is possible to reduce the number of components of the turbocharger 1 and thereby compactify the turbocharger 1.

As described above, ejected air G prevents the deposit from adhering to surfaces of the adhesion preventing part 4. However, if the deposit D3 firmly adheres to the surface of the adhesion preventing part 4 and is hardly removed from the surface with ejected air G alone, the deposit D3 may degrade the turbocharger 1 in the performance.

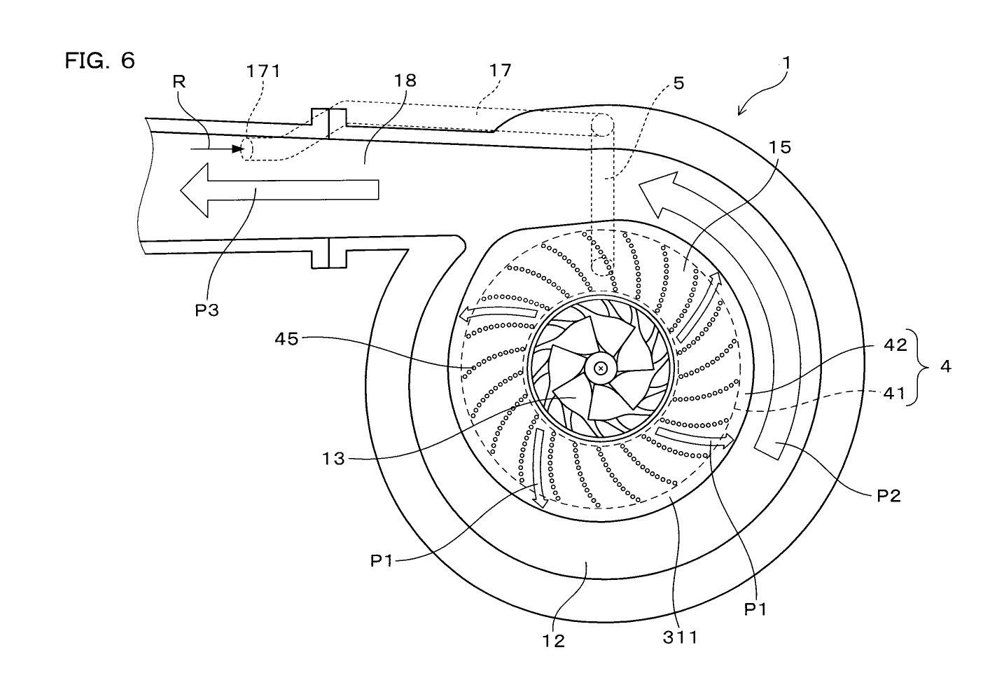

Hence, at least one of the compressor housing 2 and the bearing housing 3 includes the depurant injection port 6 for supplying the depurant S having compatibility with deposits to the tank part 41. This configuration allows the depurant S to be supplied from the tank part 41 through the ejection holes 45 of the adhesion preventing part 4 to the diffuser surface 222 or the opposite surface 311, as shown in FIG. 5. Accordingly, the deposit D3 can be removed with the depurant S even if the deposit D3 firmly adheres to the surface of the adhesion preventing part 4.

In addition, since the depurant is supplied to the tank part 41 through the air supply passage 5, any supply passages for supplying the depurant to the tank part 41 need not be provided newly. That is, the air supply passage 5 has the role of supplying the depurant, as well as air, to the tank part 41. It is therefore possible to more securely prevent deposits from accumulating in the diffuser passage 15, without complicating the structure of the turbocharger 1 in particular.

The air supply passage 5a communicated with the tank part 41a provided in the compressor housing 2 and the air supply passage 5b communicated with the tank part 41b provided in the bearing housing 3 are coupled with each other. Consequently, the depurant can be supplied from the common depurant injection port 6 to both the tank part 41a and the tank part 41b. Thus, a single depurant injection port 6 suffices for depurant supply. Also, work efficiency in injecting the depurant can be promoted.

As described above, according to the present embodiment, it is possible to provide a turbocharger capable of preventing the adhesion of deposits in a diffuser passage.

### Embodiment 2

The present embodiment is an example of the turbocharger 1 configured so that air in the tank part 41 is ejected through the ejection holes 45 to the diffuser passage 15 by an ejector effect caused when compressed air (supply air) passes through the diffuser passage 15, as shown in FIGS. 6 to 9. The depurant filled in the tank part 41 circulates around the surfaces of the surface forming part 42 through the ejection holes 45 due to capillary action or an ejector effect caused when compressed air (supply air) passes through the diffuser passage 15.

In the present embodiment, the compressor housing 2 and the air supply passage 5 formed in the bearing housing 3 are configured in the same way as in Embodiment 1 (FIG. 1).

In the present embodiment, the tank part 41 of the adhesion preventing part 4 is communicated with an air flow path in the downstream of the diffuser passage 15 (downstream of the outlet port 18 in the present embodiment) by the air supply passage 5 and a feed pipe 17 connected to this passage, as shown in FIG. 6. Thus, the present embodiment is configured so that part of compressed air is supplied to the tank part 41.

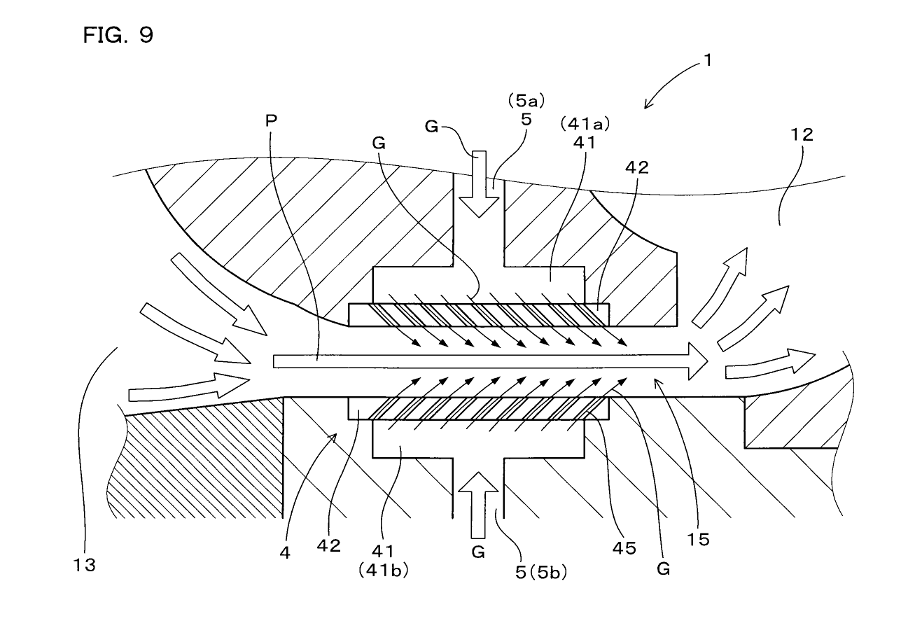

In addition, the present embodiment is configured so that air G supplied to the tank part 41 spouts out to the diffuser passage 15 through the ejection holes 45 by the ejector effect caused when compressed air P passes through the diffuser passage 15, as shown in FIG. 9.

In the diffuser passage 15, the compressed air P compressed by the impeller 13 flows from the impeller 13 side which is an upstream side of the air flow to the discharge scroll chamber 12 side which is a downstream side of the air flow. That is, the compressed air flowing from the impeller 13 side to the discharge scroll chamber 12 side as shown by arrows P1 in FIG. 6 flows down to the outlet port 18 on the downstream side, while spirally circling inside the discharge scroll chamber 12 as shown by an arrow P2. Thereafter, the compressed air is led out from the outlet port 18 to the outside (the internal-combustion engine side) as shown by an arrow P3.

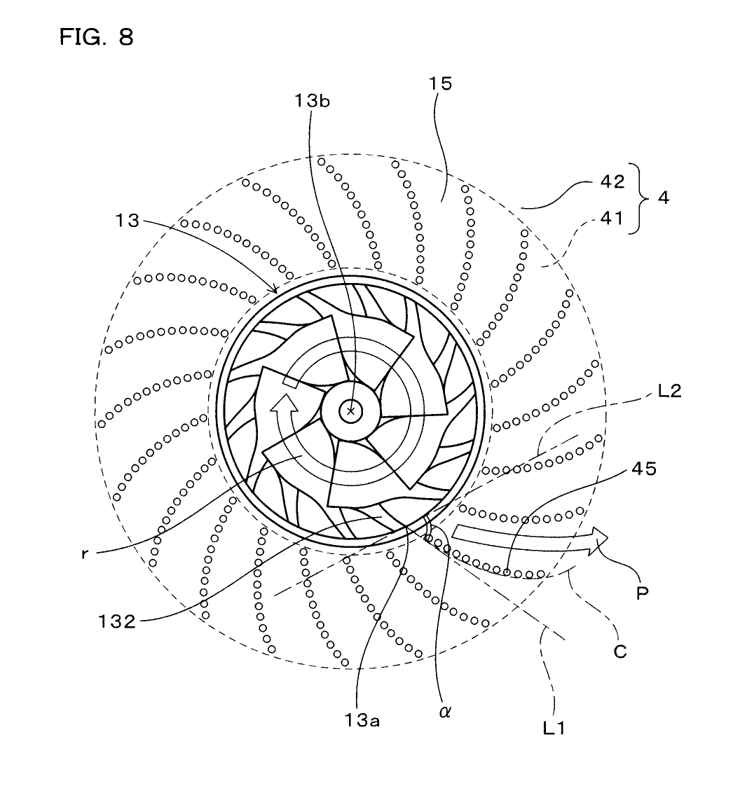

As shown in FIG. 8, the blades 132 of the impeller 13 are inclined to a virtual straight line L2 along the tangential (outlet tangential) direction of each outer edge 13a of the impeller 13. Thus, an angle (backward angle) a formed by each blade 132 and the virtual straight line L2 at the outer edge 13a of the impeller 13 is approximately 60°.

As shown in FIG. 6, the feed pipe 17 is connected to an air flow path located on the downstream side of the outlet port 18. Consequently, the tank part 41 is configured so as to be communicated with the air flow path on the downstream of the diffuser passage 15 (downstream of the outlet port 18 in the present embodiment) through the feed pipe 17 and the air supply passage 5, so that part of compressed air is supplied to the tank part 41.

A suction inlet 171 of the feed pipe 17 is open toward the upstream side of a stream of compressed air in the air flow path. Accordingly, a flow direction R of compressed air flowing from the suction inlet 171 into the feed pipe 17 is opposite to the direction (P3) of compressed air flowing through the air flow path.

The material of the surface forming part 42 of the adhesion preventing part 4 may be, for example, aluminum or iron.

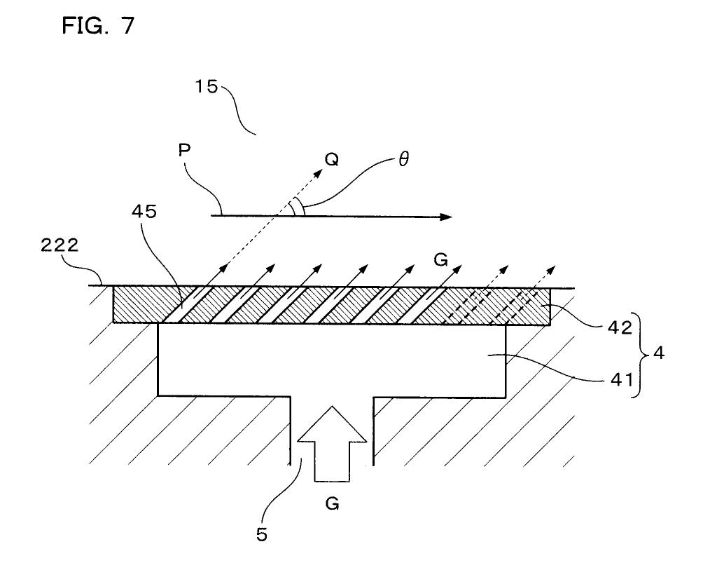

A multitude of microscopic ejection holes 45 open to the diffuser passage 15 are formed in the surface forming part 42. As shown in FIG. 7, the ejection holes 45 penetrate from the tank part 41 to the diffuser passage 15. The diameter of each ejection hole 45 may be, for example, approximately 0.5 μm to 50 μm. Consequently, the backward flow of compressed air through the ejection holes 45 can be effectively prevented while properly suppressing pressure loss when air passes through the ejection holes 45. In the present embodiment, the diameter of each ejection hole 45 is approximately 1.0 μm.

Each of the multitude of microscopic ejection holes 45 is formed so that a formation direction Q of each hole from the tank part 41-side opening toward the diffuser passage 15-side opening inclines to the downstream side of the diffuser passage 15 (discharge scroll chamber 12 side). That is, an angle θ formed by the formation direction Q of each ejection hole 45 and the flow direction P of compressed air in the diffuser passage 15 is smaller than 90°. In the present embodiment, the angle θ is approximately 40°. The flow direction P is parallel to the diffuser surface 222.

As shown in FIG. 8, in the diffuser passage 15, the multitude of microscopic ejection holes 45 are formed along a virtual curved line C assumed in the diffuser passage 15. The virtual curved line C curves toward a direction opposite to a rotational direction r of the impeller so as to be farther away from a virtual straight line assumed to extend outward from a starting point on an outer edge of the impeller in a direction of an orientation of a blade of the impeller according as the virtual curved line extends toward downstream of the diffuser passage from a starting point being at the same position as the starting point of the virtual straight line. In addition, the ejection holes 45 are formed along the virtual curved lines C in FIG. 8 which is assumed to be provided at predetermined angular intervals around a shaft center 13b of the impeller 13.

The density with which the ejection holes 45 are arranged is not limited in particular, and may be varied as appropriate to the extent of being able to obtain a required adhesion preventing effect. For example, the ratio of an area which the openings of the ejection holes 45 account for to the surfaces of the diffuser passage 15 may be set to approximately 20% to 50%.

The other configuration of Embodiment 2 is the same as Embodiment 1. Unless otherwise specified, the same reference numerals and characters as those in Embodiment 1 are used for the same components as those of Embodiment 1.

Like Embodiment 1, the present embodiment can prevent the adhesion of deposits in the diffuser passage 15. In addition, a route of air supply to the tank part 41 can be simplified to enable a reduction in the number of components of the turbocharger 1, a reduction in the number of assembly steps, and an improvement in mountability on vehicles and the like.

In the present embodiment, air is ejected from the tank part 41 of the adhesion preventing part 4 through the ejection holes 45 due to the ejector effect (entrainment effect) caused by supply air passing through the diffuser passage 15, as described above. Air to be supplied to the tank part 41 therefore need not be pressurized in particular with a pressurizing pump. In addition, compressed air inside the diffuser passage 15 can be prevented from flowing back to the tank part 41 side through the ejection holes 45, without incorporating any back-flow prevention valves.

In addition to the above-described effect, the present embodiment has the same working effect as Embodiment 1.

In the present embodiment, the feed pipe 17 is connected to an air flow path located on the downstream side of the outlet port 18. The configuration of the feed pipe is not limited to such configuration, however. The feed pipe 17 has only to be connected to any of air flow paths on the downstream of the diffuser passage 15. For example, the turbocharger may be configured so that part of compressed air is bypassed from an intake manifold connecting the discharge scroll chamber 12 and the internal-combustion engine to the tank part 41 by connecting the suction inlet of the feed pipe to the intake manifold.

In Embodiment 2, an example has been cited in which a metal plate including a multitude of through-holes (ejection holes 45) bored therein is used for the surface forming part 42 of the adhesion preventing part 4. Instead, the surface forming part may be composed of a porous body, such as porous resin. In this case, the microscopic holes of the porous body function as the ejection holes.

### Embodiment 3

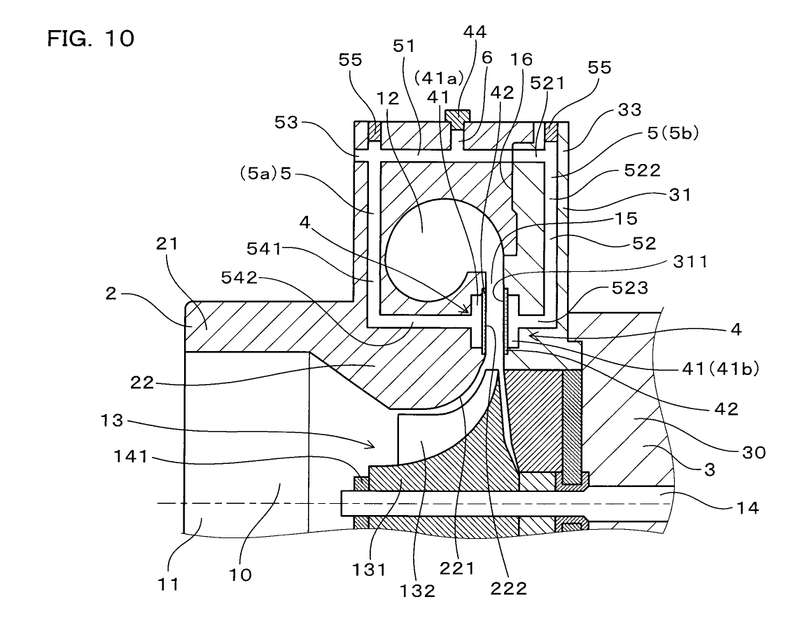

The present embodiment is an example in which the bearing housing 3 is configured by combining a bearing main unit 30 and a back plate 31, as shown in FIG. 10. The back plate 31 is disposed between the bearing main unit 30 and the compressor housing 2 and faces part of an air flow path. That is, in the present embodiment, the back plate 31 which is a member separate from the bearing main unit 30, constitutes part of the bearing housing 3 including the flange portion 33 shown in Embodiment 1.

In the case of the present embodiment, an opposite surface 311 is formed on the compressor-side surface of the back plate 31. In addition, at least parts of the adhesion preventing part 4 and the air supply passage 5 are formed in the back plate 31.

The other configuration of this Embodiment is the same as Embodiment 1. Unless otherwise specified, the same reference numerals and characters as those in Embodiment 1 are used for the same components as those of Embodiment 1.

The same working effect as the working effect of Embodiment 1 can also be obtained in the present embodiment.

In Embodiments 1 and 2, an example has been cited in which a feed pipe is connected to the air supply passage 5. The embodiments need not necessarily have a configuration in which the feed pipe is installed, however. For example, Embodiment 2 may have a configuration in which part of the air supply passage is formed in a portion of the compressor housing 2 constituting the outer shell of the outlet port 18 and is made open to an air flow path in the vicinity of the outlet port 18.

1. A turbocharger comprising:
a compressor housing provided therein with an air flow path in which an impeller is placed; and
a bearing housing rotatably supporting a rotor shaft having one end to which the impeller is fixed, wherein
the air flow path comprises an intake port for sucking air to the impeller, and a discharge scroll chamber formed on an outer circumferential side of the impeller in a circumferential direction to guide compressed air discharged from the impeller to the outside,
the compressor housing comprises a shroud surface opposed to the impeller, and a diffuser surface extending from the shroud surface toward the discharge scroll chamber,
the bearing housing comprises an opposite surface opposed to the diffuser surface of the compressor housing and forming a diffuser passage between the opposite surface and the diffuser surface,
each of the diffuser surface of the compressor housing and the opposite surface of the bearing housing is provided with an adhesion preventing part for preventing adhesion of deposits,
the adhesion preventing part comprises a surface forming part having a multitude of fine ejection holes open to the diffuser passage, and a tank part covered with the surface forming part from a side of the diffuser passage, and is configured so as to eject air from the tank part through the ejection holes of the surface forming part to the diffuser passage,
the compressor housing and the bearing housing comprise air supply passages for supplying air to the tank parts, and
at least one of the compressor housing and the bearing housing comprises a depurant injection port for supplying a depurant compatible with the deposit to the tank part through the air supply passage.

2. The turbocharger according to claim 1, wherein the air supply passage communicated with the tank part provided in the compressor housing and the air supply passage communicated with the tank part provided in the bearing housing are connected to each other.

3. The turbocharger according to claim 1, wherein the multitude of fine ejection holes are formed along virtual curved lines assumed in the diffuser passage, each the virtual curved line curving toward a direction opposite to a rotational direction of the impeller so as to be farther away from a virtual straight line assumed to extend outward from a starting point on an outer edge of the impeller in a direction of an orientation of a blade of the impeller according as the virtual curved line extends toward downstream of the diffuser passage from a starting point being at the same position as the starting point of the virtual straight line.

4. The turbocharger according to claim 3, wherein the air supplied to the tank part spouts out to the diffuser passage through the ejection holes by an ejector effect caused when the compressed air passes through the diffuser passage.
